(19) United States
(12) Patent Application Publication
(10) Pub. No.: US 2007/0071863 A1
(43) Pub. Date: Mar. 29, 2007

(54) VISUALLY APPARENT OAT-CONTAINING CHIPS PROVIDING HEALTH ADVANTAGES

(75) Inventors: Peter H. Mattson, Hillsborough, CA (US); Donald G. Warnock, Madera, CA (US)

Correspondence Address: THADDIUS J. CARVIS, 102 NORTH KING STREET, LEESBURG, VA, 20176, US

(73) Assignee: CORAZONAS FOODS, INC., Mill Valley, CA (US)

(21) Appl. No.: 11/534,925

(22) Filed: Sep. 25, 2006

Related U.S. Application Data
(60) Provisional application No. 60/720,631, filed on Sep. 26, 2005.

(51) Int. Cl. A21D 10/00

(52) U.S. Cl. 426/549

(57) ABSTRACT

Masa products, processes for preparing them and dietary regimens employing them are described. A masa product, preferably a tortilla chip, comprises a cooked, sheeted dough comprising visually apparent oat groats. The oats are preferably visually identifiable on the surface of the chips and cover at least about 10% of the total exterior surface of the chip. The process for preparing the chips comprises the steps of: forming a dough from water, masa and oat groats; forming the dough into sheeted preforms; baking the sheeted preforms; holding the preforms following baking for a period of time sufficient to permit the moisture within the preforms to equilibrate; and frying the preforms following equilibration. In one preferred form, the packaged product of the invention will comprise: an air-tight package; and tortilla chips prepared from a dough comprised of masa and oats, the chip having clearly identifiable pieces of oat covering at least 10% of the total exterior surface of the chip. A regimen is also provided by the for reducing serum cholesterol, and comprises: at least 3 days out of 7, consuming a serving of tortilla chips comprising: a baked, fried sheeted hydrated mixture comprising masa and oats, and oil containing cholesterol-lowering phytosterols.

### RELATED APPLICATION AND PRIORITY CLAIM

This application is a regular U.S. application claiming priority to U.S. Provisional Patent Application Ser. No. 60/720631, filed Sep. 26, 2005, the disclosure of which is incorporated herein in its entirety.

### BACKGROUND OF THE INVENTION

The invention relates to corn masa products, particularly tortillas, preferably tortillas and corn chips, most preferably tortilla chips, tortilla cups, tortilla shells and tortilla bowls, which contain visually apparent oats as a nonverbal communication to the consumer that the product provides the known advantages of oats for cholesterol lowering effects, just as that claim is preferably made on the label and can be substantiated by clinical evidence in human subjects.

Food is not only essential to life, it adds to the richness of the human experience. Foods can be a source of healthy factors and also unhealthy ones. See, generally, The Surgeon General's Report on Nutrition and Health. Washington, DC: US Dept of Health and Human Services; 1988 and DHHS (PHS) publication No. 88-50210. The Surgeon General's report states, “For two out of three adult Americans who do not smoke and do not drink excessively, one personal choice seems to influence long-term health prospects more than any other: what we eat.” (p 1). The report goes on to point out that the type and amount of foods are implicated in general health.

Snack foods have generally been perceived by consumers unhealthy, but a number of new products are being proposed to add positive health benefits. One idea has been to encourage increased consumption by offering a positive benefit and possibly erase guilt associated with eating snack foods. In this regard, see U.S. Pat. No. 6,846,501, to Prosise, et al., and United States Patent Publication No. 2005/0042355 to Perlman, et al, and U.S. Pat. No. 6,610,320 to Schmitz, et al, and the references cited therein, all of which are incorporated by reference. The Perlman, et al, publication describes a variety of foods, including potato chips and tortilla chips, containing an oxidation-resistant fat-based composition substantially free of exogenous solubilizing and dispersing agents for phytosterols. The fat-based composition is said to include between 75% and 98% by weight of at least one triglyceride-based edible oil or fat, and between 2% and 25% by weight of non-esterified phytosterols. In the specific case of tortilla chips, a clinical human pilot study evaluated the effect of tortilla chips, wherein the consumption of a test diet including two, one ounce bags provided 1.5 grams of phytosterols per day, was found to provide a clinically meaningful decline in LDL cholesterol without lowering beneficial HDL cholesterol. See, also, K. C. Hayes, A. Pronczuk and D. Perlman; Nonesterified Phytosterols Dissolved and Recrystallized in Oil Reduce Plasma Cholesterol in Gerbils and Humans; The American Society for Nutritional Sciences J. Nutr.; 134:1395-1399, June 2004.

There is a growing understanding of how specific foods—and, in many cases, their chemical components—can provide specific health benefits. This knowledge is being utilized on an increasing basis for the development of “functional foods”—foods which offer specific health benefits. However, there is consumer resistance to many of these. Given the abundance of desirable foods available to most people in developed countries, “eat your spinach” messages are not as influential as their authors might hope. People tend to eat what they want, not necessarily what is good for them. Thus, while healthy foods may be desired by a broad range of consumers, these are frequently not as well received as presales indicators might predict.

A lack of positive acceptance for some foods making justified health claims has been a hurdle for food manufacturers for a number of years. There are various reasons. Evidence tends to indicate that foods that are presented with a pronounced reliance on ingredients with “chemical” sounding names are not preferred for that reason despite the fact that sound clinical evidence is present to establish significant nutritional benefits. For example, respondents of one study in Denmark believed that functional foods provided convenience by enriching the daily diet. This convenience may be perceived as promoting an ‘easy way’ of healthy living. However, consumers also perceived unnaturalness and uneasiness toward taste changes, higher prices, doubt about the enrichment effect, enrichment dosage questions, and uncertainty toward eating functional food products. These perceptions, and others, present barriers to successful marketing of foods that would be good for the consumers, despite some positive attitudes toward the nutritional goals of functional foods. [Poulsen, J. (1999). Danish consumers' attitudes towards functional foods. MAPP working paper, 62. Aarhus School of Business].

As noted above, Perlman, et al., describe food products containing cholesterol reducing food ingredients known generally as phytosterols, but these ingredients sound quite chemical. Other publications also discuss other products and there are some products on the market offering these very compositions. This is meant to satisfy the awareness in parts of the general public of many of the risks associated with cholesterol and related blood lipid factors. However, while the evidence is clear that phytosterols can have positive influences in this realm, sales of products containing these—i.e., consumers taking advantage of the known health benefits—are far less than what some experts think desirable.

There is a present need in the art for a product which can more effectively provide a link between the consumers desire for a healthy product and their perception of the product as something healthful enough for them to buy and consume.

### BRIEF DESCRIPTION OF THE INVENTION

It is an object of the invention to provide corn masa products, particularly chips, preferably tortillas and corn chips, most preferably tortillas, which by their appearance provide a nonverbal communication to the consumer that the product is healthy.

It is another object of the invention to provide packaged corn masa products which inform the consumer that the product offers the known advantages of oats for cholesterol lowering effects by the visual appearance of the products and a label claim to that effect.

It is yet another and more specific object of the invention to provide tortilla chips having a uniquely desirable appearance, texture and taste.

It is yet another object of the invention to provide processes for preparing products of the type noted above.

It is yet another object of the invention to provide a regimen for lowering serum cholesterol utilizing the products of the type noted above.

These and other objects are achieved by the invention which provides masa products, processes for preparing them and dietary regimens employing them. In the product aspect, the invention provides a masa product comprising a cooked, sheeted dough comprising visually apparent oat groats. In a preferred form, the masa product is prepared from a dough comprised of masa and oats and is in the form of a chip wherein oats are clearly identifiable on the surface of the chips and cover at least 10% of the total exterior surface of the chip.

In one aspect of the process for preparing the products of the invention, the process will comprise the steps of: forming a dough from water, masa and oat groats; forming the dough into sheeted preforms; baking the sheeted preforms; holding the preforms following baking for a period of time sufficient to permit the moisture within the preforms to equilibrate; and frying the preforms following equilibration.

In one preferred form, the packaged product of the invention will comprise: an air-tight package; and tortilla chips prepared from a dough comprised of masa and oats, the chip having clearly identifiable pieces of oat covering at least 10% of the total exterior surface of the chip. Desirably, the chips have a bulk density of less than 80 grams per liter. In a preferred form, the package comprises text declaring that the chips provide a cholesterol-lowering effect.

A regimen is also provided by the for reducing serum cholesterol, and comprises: at least 3 days out of 7, consuming a serving of tortilla chips comprising: a baked, fried sheeted hydrated mixture comprising masa and oats, and oil containing cholesterol-lowering phytosterols.

Many preferred features of the invention will be described below.

### BRIEF DESCRIPTION OF THE DRAWINGS

The invention will be better understood and its advantages will become more apparent when the following detailed description is read in light of the accompanying drawings, wherein:

FIG. 1 is a schematic diagram of a preferred process sequence for preparing the products of the invention.

FIG. 2 is a photographic view of a preferred form of tortilla chip according to the invention.

### DETAILED DESCRIPTION OF THE INVENTION

The invention relates to corn masa products, particularly tortillas, preferably tortillas and corn chips, most preferably tortilla chips, tortilla cups, tortilla shells and tortilla bowls, which contain visually apparent oats as a nonverbal communication to the consumer that the product provides the known advantages of oats for cholesterol lowering effects, just as that claim is preferably made on the label and can be substantiated by clinical evidence in human subjects.

By virtue of their unique formulation and processing employing oats in recognizable form, the products of the invention send a message to the consumers about potential health benefits. The oats are a wholesome ingredient known for heart healthy properties, and are made strongly visually apparent by the invention. This visual appearance is combined with a second source of benefit (namely, phytosterols) that might not be as acceptable if it were the lead ingredient. The invention prominently shows the consumer apparently whole oats in snack chip to visually support a heart healthy claim on the package, but also provide highly bioactive forms of phytosterols as part of the composition—the combined amounts of whole oats and phytosterols being sufficient to provide a significant decrease in plasma cholesterol when consumed in reasonable amounts. A representative package claim is as follows: “contains plant sterols . . . (clinically) proven to help lower cholesterol”.

By the term “phytosterols” we mean those materials defined as such in the above-noted United States Patent Publication No. 2005/0042355 to Perlman, et al., in particular either plant sterols, stanols, or combinations thereof, including beta-sitosterol, beta-sitostanol, campesterol, campestanol, stigmasterol, stigmastanol, brassicasterol, brassicastanol, clionasterol and clionastanol (collectively termed phytosterol or phytosterols). For lowering plasma cholesterol, the phytosterol should be dissolved in an edible oil or other solvent so that it can enter micelles in the small intestine to inhibit the absorption of cholesterol. In addition to the specific non-esterified phytosterols described therein, which description is incorporated herein by reference, we intend to include those other forms described therein and/or otherwise included within 21 CFR §101.83, which regards permitting health claims.

By the term “cholesterol-lowering effect” we mean that a significantly reduced serum cholesterol will be observed for subjects on a regimen of eating the subject food in normal serving amounts on a regular basis. A serving size will typically be from about 0.5 to about 5.0 grams per day, preferably as defined in 21 CFR §101.83. This is intended to provide at least about 0.5 grams of oats and at least about 1.3 grams of phytosterols per day. The regimen will typically entail eating at least three (e.g., 5 to 7) servings per week, and preferably at least a serving per day (preferably two) of the chips of the invention or other phytosterol containing food, for a period of time sufficient for the cholesterol lowering effect to be observed. Preferred regimens will entail eating one serving twice daily.

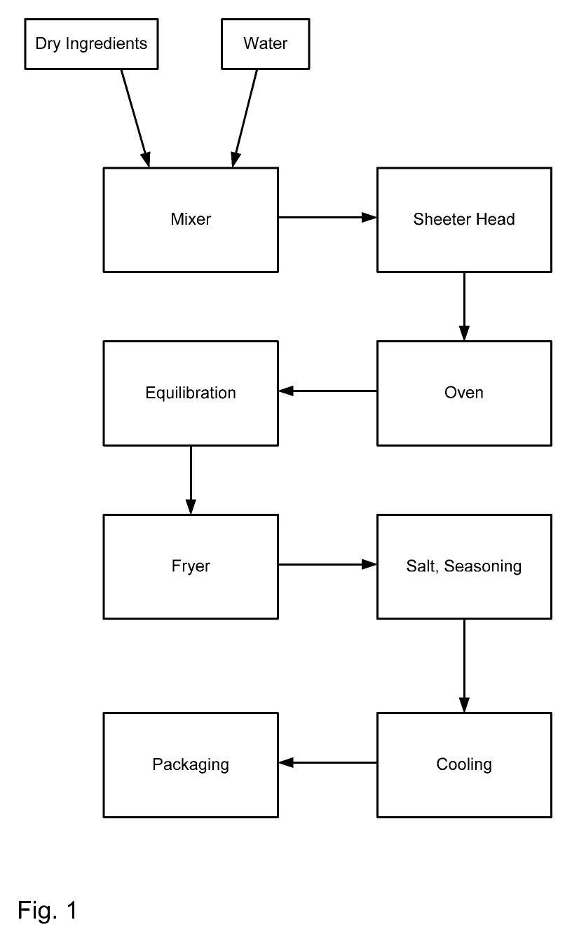

Reference is now made to FIG. 1 as a guide to the following description of a preferred process for preparing tortilla chips according to the invention. By the term “tortilla chip” we mean a chip comprised principally of masa, which is formed into a hydrated dough, formed into pieces, baked and then fried. It is an advantage and improvement of the invention that the dough also comprises oats, which provide a clear visual marker that they are present to provide cholesterol lowering effect. Also, the tortilla chip will necessarily contain frying oil, which advantageously according to the invention can include cholesterol-lowering phytosterols. The process begins by measuring and mixing the following dry ingredients.

Parts by Weight

| Dry Ingredients | Broad | Preferred |
|---|---|---|
| Whole corn stone ground masa | 50-80 | 70 |
| Oat groats | 10-50 | 30 |
| Oat Fiber | 0-8 | 4.0 |
| Calcium | 0-5 | 1.5 |

“Corn masa” includes the cooked corn in either its wet or dry (masa flour) states. The masa employed is preferably prepared by stone grinding whole corn which has been cooked in lime water. The masa will preferably be supplied in a range of grind sizes from medium to fine, as those terms are understood in the art. The amounts of the various grinds will be a matter of choice for their effect on texture. In one preferred form, the ratio of medium fine to fine of about 6:5.

The oats are preferably oat groats. Oat groats are made by dehulling oats and removing fines and broken kernels. Thus, the oat groats are present as discrete pieces (i.e., dehulled kernels) of oats. They are desirably large, preferably having a particle size permitting a majority to be retained on a U.S. #10 wire mesh. Preferably, only a small percentage, e.g., less than about 10% (desirably, less than about 5%) will pass through a U.S. #10 wire mesh. The formula also preferably contains calcium in an amount sufficient to provide calcium in dietary significant amount, e.g., each serving will preferably contain at least 10% and preferably at least 25%, of the daily value. As used throughout this description, the term “daily value” is given the meaning supplied by an U.S. FDA in a circular entitled “Daily Values Encourage Healthy Diet” by Paula Kurtzweil (http ://www.fda.gov/fdac/special/foodlabel/dvs.html). The circular explains that DRVs (daily recommended values) serve as the basis for calculating percent Daily Values. DRVs are stated to be for nutrients for which no set of standards previously existed. DRVs for the energy-producing nutrients (fat, carbohydrate, protein, and fiber) are based on the number of calories consumed per day. For labeling purposes, 2,000 calories has been established as the reference for calculating percent Daily Values.

The dry ingredients may also contain flavors, e.g., lime, and/or a soluble fiber ingredient, such as oat fiber, e.g., an oat fiber concentrate, or other form of soluble fiber. Fiber is a very desirable additive and can be employed in a dietary significant amount, e.g., from about 1 to about 8%, and more typically about 3 to about 5%. In this regard, the description of United States Patent Publication No. 2005/0100619 is incorporated herein by reference for its listing of suitable fibers, preferably those capable of inhibiting ileal bile acid absorption.

These dry ingredients, which can be supplemented as desired, are mixed with water in sufficient amount, e.g., about 35 to about 50%, in a suitable mixer such as a Peerless sigma blade mixer, to form a dough. The dough will be mixed for a time sufficient to form a sheetable dough, e.g., at least about 5 minutes and typically from about 10 to about 15 minutes. A preferred target moisture for the dough is about 55% at this stage, with some moisture coming from the ingredients and some being added.

The dough is fed to a sheeter head, typically comprised of a pair of sheeting rollers, one of which is configured to impart a particular shape to the dough. Typically a third, smaller transfer roller receives the shaped dough sheet from the nip of the sheeting rollers. The dough can be cut into any number of two dimensional shapes after sheeting to the desired thickness. Suitable shapes can be formed by any combination of lines or curves. The projected shape of the dough piece can include but not be limited too parallelepipeds, polygons, circles, ovals, parabolas, ellipses, or sections of any thereof. Preferred shapes include squares, diamonds, rectangles, trapezoids, parallelograms, triangles, circles, ovals, bowties, stars, pin wheels or ellipses, more preferred shapes include ovals, circles, diamonds and triangles, and most preferred includes triangles. Suitable means, such as a piano wire or the like, is provided to remove the dough from the transfer roller as individual chip preforms.

The individually cut chip preforms are collected on a moving belt, such as a stainless steel mesh belt, and moved through a three-tiered oven, wherein each tier has a gas heater under a belt. The oven temperature is about 700° F. on average and each of three passes across the length of the oven takes about 10 to about 20 seconds, e.g., typically about 18 seconds in one preferred embodiment. The belt for the first, top tier moves the length of the oven (e.g., about 12 to about 14 feet) drops the chip preforms onto the belt for the second tier just below it. That belt moves the length of the oven in the opposite direction and drops the chip preforms onto the belt for the third tier just below it. The belt for the third tier moves the length of the oven in the opposite direction as the previous tier and drops the chip preforms onto a belt which carries the resulting baked chip preforms from the oven and to an equilibrium zone where they are given a chance to rest and for the moisture to equilibrate throughout the chip.

The baking step reduces the moisture content of the chip preforms to from over about 50%, e.g., about 55%, down to less than about 35%, e.g., about 32%. The baking causes the outer surface of the chip preforms to become quite dry and firm relative to the interior, such that an outer skin layer could be removed from the central portion which would still be dough like. The texture is made more uniform throughout by resting the just baked chip preforms for a suitable time to decrease this strong textural contrast and eliminate the ability to simply separate an outer skin, say with a knife. The baked chip preforms are dropped onto a belt for equilibration at a reduced belt speed which causes the baked chip preforms to overlap into multiple layers about a half an inch or so deep. For chip preforms of the preferred dimensions, the overlapping will result in a bed depth of from about 4 to about 8 chips, e.g., about 5 to about 6 chips in depth. The equilibration will take as long as is necessary to achieve the desired textural homogeneity and to bring them to within a few degrees of ambient temperature, e.g., preferably from about 75° to about 85° F. Typically, the equilibration step can be completed in less than about 10 minutes, e.g., about 8 minutes.

The resulting equilibrated, baked chip preforms are then moved to a belt for moving them through a deep fat fryer. The oil in the fryer is preferably maintained at a temperature of at least about 350° F., e.g., about 360° F. in the case of one preferred oil, namely high oleic safflower oil. By the term “oil” we mean any food-acceptable triglyceride or substitute in either liquid or solid form that is suitable for frying and dissolving the phytosterols in suitable amounts. For a description of preferred oils for frying and preferred concentrations of phytosterols in the oils, reference is specifically made to United States Patent Publication No. 2005/0042355 to Perlman, et al. Those skilled in the art will also recognize as suitable the frying oils identified in United States Patent Publication No. 2005/0042355 to Zimmerman, et al, which include for example soybean oil, corn oil, cottonseed oil, sunflower oil, mid-oleic sunflower oil, high oleic sunflower oil, palm oil, coconut oil, canola oil, fish oil, lard and tallow, which may have been partially or completely hydrogenated or modified otherwise, as well as non-toxic fatty materials having properties similar to triglycerides, herein referred to as non-digestible fats, which materials may be partially or fully indigestible. Among the substitutes for triglycerides are olestra, salatrim, and others known for such purposes, again reference is made to United States Patent Publication No. 2005/0042355 to Zimmerman, et al

The frying step produces finished chips, preferably with a light golden brown color, and reduces the moisture to less than about 2%, e.g., about 1.5%. The frying step should take as long as necessary to achieve the moisture and color targets indicated above or as otherwise required. Typical fry times at the indicated conditions will be adopted to meet color, texture and moisture goals for individual products, e.g., about 1.75 minutes. Where the oil comprises phytosterols in an amount of at least about 2%, e.g., from about 5 to about 15%, preferably about 9 to about 12%, e.g., at a ratio of about 1:8 relative to the oil, and the chips will contain residual oil in an amount of from about 25 to about 40%, e.g., from about 28 to about 35%, a serving size of chips of from about 0.5 to about 2.0 ounces, e.g., about 1 ounce, can be effective in providing the desired amount of phytosterols in the diet for a suitable regimen. The oil preferably contains from about 2% to about 20% triglyceride-recrystallized phytosterols, such as described in the above U.S. Patent Publication No. 2005/0042355.

Following frying the resulting chips are conveyed under a seasoning spreader, such as to apply salt or other seasonings as desired. In those cases where more seasoning is desired, a coating real can be employed and any desired dry mix of seasonings, herbs, cheese flavors and the like can be dusted on the chips as they are tumbled in the coating reel.

The final chips with desired amounts of salt and/or other seasonings and flavors are ready for packaging, which is preferably done as an immediate step at the end of the seasoning or salting procedure. Packaging is preferably in bags which have been evacuated of oxygen but filled with a cushioning gas such as nitrogen. Each of the tortilla chips will contain visually identifiable pieces of oat. By the term “visually identifiable pieces of oat” we mean that oat pieces can be discerned by inspection visually by a human adult without the aid of special equipment. Preferably the oats are identifiable on the surface of the chips and cover at least about 5%, preferably at least about 10%, e.g., from about 15% to about 40%, of the total exterior surface of the chip.

In one preferred form, the packaged product of the invention will comprise: an air-tight package; and tortilla chips prepared from a dough comprised of masa and oats, the chip having clearly identifiable pieces of oat, e.g., covering at least about 10% of the total exterior surface of the chip. Desirably, the chips have a bulk density of less than about 80 grams per liter. In a preferred form, the package comprises text declaring that the chips provide a cholesterol-lowering effect.

A regimen is also provided by the for reducing serum cholesterol, and comprises: at least 3 days out of 7, consuming a serving of tortilla chips comprising: a baked, fried sheeted hydrated mixture comprising masa and oats, and oil containing cholesterol-lowering phytosterols.

In addition to chip products, the invention can be utilized to provide other types of foods for both snack and main meal consumption. The regimen described above can be adapted to employ foods of other composition to provide a preferred twice daily portion of food containing the phytosterols. Preferably, the tortilla chips or other phytosterol containing food is consumed at least twice daily on a continuing basis.

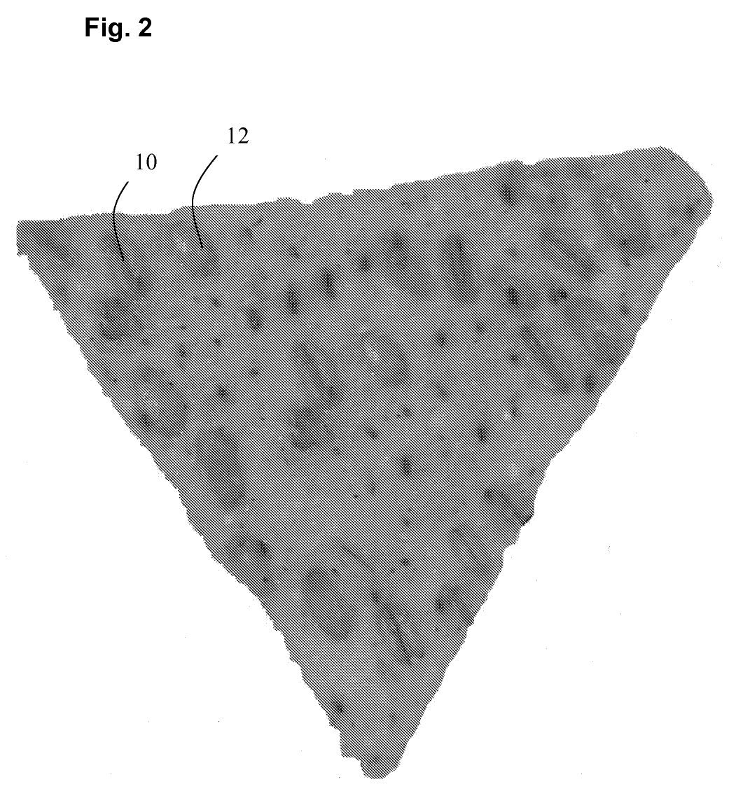

FIG. 2 is a photographic representation of a tortilla chip made in accord with the preferred procedure. The presence of oat groats can be visually observed. Preferably, the oat groats are visually apparent on the surface of the chips and cover at least about 10% of the total exterior surface of the chip. More preferably, the chips contain sufficient oats in the form of oat groats to have visually apparent pieces of oat covering from about 15% to about 40% of the total exterior surface of the chip. The photograph shows oat groats apparent from one side of an oat groat is shown at 10 and another from the other side is shown at 12.

The above description is for the purpose of teaching the person of ordinary skill in the art how to practice the invention. It is not intended to detail all of those obvious modifications and variations, which will become apparent to the skilled worker upon reading the description. It is intended, however, that all such obvious modifications and variations be included within the scope of the invention which is defined by the following claims. The claims are meant to cover the claimed components and steps in any sequence which is effective to meet the objectives there intended, unless the context specifically indicates the contrary.

1. A masa product comprising cooked, sheeted dough comprising visually apparent oat groats.

2. A masa product prepared from a dough comprised of masa and oats in the form of a chip wherein oats are visually apparent on the surface of the chips and cover at least 10% of the total exterior surface of the chip.

3. A tortilla chip according to claim 2 wherein the chip contains sufficient oats in the form of oat groats to have visually apparent pieces of oat covering from about 15% to about 40% of the total exterior surface of the chip.

4. A tortilla chip according to claim 2 wherein the chip further comprises oil containing cholesterol-lowering phytosterols.

5. A tortilla chip according to claim 2 wherein the oil contains from about 2% to about 20% triglyceride-recrystallized phytosterols.

6. A tortilla chip according to claim 2 wherein the oats are used in a form providing at least a majority of their particles by weight of a size to be held on a U.S. 10 mesh screen.

7. A tortilla chip having a cholesterol-lowering effect, comprising: a baked, fried sheeted hydrated mixture comprising masa and oats, and oil containing cholesterol-lowering phytosterols.

8. A tortilla chip according to claim 7 wherein the oats are used in a form providing at least a majority of their particles by weight of a size to be held on a U.S. 10 mesh screen.

9. A tortilla chip according to claim 7 wherein the oats are used in a form providing at least 90% of their particles by weight of a size to be held on a U.S. 10 mesh screen.

10. A tortilla chip according to claim 7 wherein the oats comprise at least about 10% of the mixture comprising masa and oats in dry form.

11. A tortilla chip according to claim 10 wherein the oats comprise from about 15% to about 50% of the mixture comprising masa and oats in dry form.

12. Packaged tortilla chips, comprising:
an air-tight package; and
tortilla chips prepared from a dough comprised of masa and oats, the chip having clearly identifiable pieces of oat covering at least about 10% of the total exterior surface of the chip.

13. Packaged tortilla chips according to claim 12, wherein the chips have a bulk density of less than about 80 grams per liter.

14. Packaged tortilla chips according to claim 12, wherein the package comprises text declaring that the chips provide a cholesterol-lowering effect.

15. Packaged tortilla chips according to claim 12, wherein:
the oats used in preparing the chips are in a form providing at least a majority by weight of their particles of a size to be held on a U.S. 10 mesh screen, the chips have visually identifiable pieces of oat covering at least about 10% of the total exterior surface of the chips, and oil containing cholesterol-lowering phytosterols; and
the package text declares that the chips include oats and provide a cholesterol-lowering effect.

16. Packaged tortilla chips according to claim 12, wherein:
the oats used in preparing the chips are in a form providing at least a majority by weight of their particles of a size to be held on a U.S. 10 mesh screen, the chips have visually identifiable pieces of oat covering from about 15% to about 40% of the total exterior surface of the chips, and the oil contains from about 2% to about 20% triglyceride-recrystallized phytosterols
the package comprises text declaring that the chips are made from oats and provide a cholesterol-lowering effect and describing a regimen effective for that purpose.

17. A regimen for reducing serum cholesterol, which comprises: at least 3 days out of 7, consuming a serving of tortilla chips comprising: a baked, fried sheeted hydrated mixture comprising masa and oats, and oil containing cholesterol-lowering phytosterols.

18. A regimen for reducing serum cholesterol according to claim 17 wherein the tortilla chips are consumed at least 5 days out of 7.

19. A regimen for reducing serum cholesterol according to claim 17 wherein the tortilla chips or other phytosterol containing food is consumed at least twice daily on a continuing basis

20. A regimen for reducing serum cholesterol according to claim 17 wherein the oats are used in a form providing at least a majority of their particles by weight of a size to be held on a U.S. 10 mesh screen.

21. A regimen for reducing serum cholesterol according to claim 17 wherein the oats comprise at least about 20% of the mixture comprising masa and oats in dry form.

22. A regimen for reducing serum cholesterol according to claim 20 wherein the oats comprise from about 15% to about 40% of the mixture comprising masa and oats in dry form.

23. A process for preparing masa products comprising:
forming a dough from water, masa and oat groats;
forming the dough into sheeted preforms;
baking the sheeted preforms;
holding the preforms following baking for a period of time sufficient to permit the moisture within the preforms to equilibrate;
frying the preforms following equilibration.
